(19) United States
(12) Patent Application Publication
(10) Pub. No.: US 2003/0105536 A1
(43) Pub. Date: Jun. 5, 2003

(54) Open and closed loop flow control system and method

(75) Inventor: Paul A. Corbelli, LeRoy, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/011,581

(22) Filed: Dec. 4, 2001

(51) Int. Cl. G06F 7/60; G06F 17/10; G05B 19/18; G05B 11/01

(52) U.S. Cl. 700/19; 700/20; 700/2

(57) ABSTRACT

A method and system are taught for controlling an operating process. The method comprises measuring an operating process parameter, determining whether the operating process parameter is within a predetermined dead band, using a closed loop controller when the operating process parameter is within the predetermined dead band, and using an open loop controller when the operating process parameter is not within the predetermined dead band. These steps are repeated until the operating process is completed. Closed loop control uses a first model in conjunction with a plurality of configurable constants that are associated with a plurality of physical parameters of the process being controlled. Open loop control uses a second model in conjunction with a plurality of configurable constants that are associated with a plurality of physical parameters of the process being controlled.

### FIELD OF THE INVENTION

The present invention relates generally to process control systems for fluid delivery, and more particularly, to methods and apparatus for controlling fluid flow using both open-loop and closed loop process control and, most particularly, to methods and apparatus for controlling fluid flow in a photographic thin-film coating machine for improved quality, cycle time, and reliability.

### BACKGROUND OF THE INVENTION

Typically, models simulating flow control systems are used to design such systems, but are not normally used in the actual flow control system. A PID type controller is usually used for closed loop control, while open-loop control is done by manual intervention by a human operator. These control methods are not always adequate for all applications.

Advanced process control methods try to improve or optimize real-time control by using a model and a variable prediction mechanism. Depending on the model accuracy and the unknown disturbances, these allow improved response, particularly in areas where transport or process delay is a major concern (Smith predictor). These models, and the parameters associated therewith, may vary significantly over time (time-variant process). This can pose a problem for these types of controllers. Another consideration is unknown disturbances that can effect the behavior of a process.

U.S. Pat. No. 6,056,781 to Wassick et al. discloses a model predictive controller for a process control system that includes a real-time executive sequencer and an interactive modeler.

U.S. Pat. No. 6,073,619 to Baranowski discloses a fuel delivery control system that comprises a stepper motor actuated control valve under the control of a closed loop fuel control logic routine. The stepper motor is initially positioned based on an open loop value related to the given engine speed and load.

U.S. Pat. No. 5,050,560 to Plapp discloses a setting system for motor vehicles. The setting system uses a 1st sensor arrangement and control unit to manipulate the setting system and a 2nd sensor arrangement and control unit to calibrate the 1st control unit. In all cases, both units are continuously fed with measured values from the sensor arrangements and, therefore are closed loop in nature. No predictive model-based (not measurement based) open-loop and closed-loop control system is taught.

### SUMMARY OF THE INVENTION

It is therefore an object of the present invention to provide a method and apparatus for controlling fluid flow which use both open loop and closed loop control methodology.

It is a further object of the present invention to provide a method and apparatus for controlling fluid flow in a photographic thin-film coating machine.

Yet another object of the present invention is to provide an open-loop control system which relies on a compensator model when the process is outside a predetermined dead-band or process state and provide a closed-loop control system which relies on another compensator model when the process is inside a predetermined dead-band or process state.

Briefly stated, the foregoing and numerous other features, objects and advantages of the present invention will become readily apparent upon a reading of the detailed description, claims and drawings set forth herein. These features, objects and advantages are accomplished by developing a compensator model for both the open-loop and the closed-loop control systems and using process operating conditions to determine when the open-loop and the closed-loop logic are used. Process control using the open-loop model is employed when the process conditions are outside a predetermined dead-band (e.g., +/−10% from set point), as well as under certain process states or operating conditions, where feedback measurements are potentially unreliable and could cause harm to the process. Disturbances and process conditions (e.g. viscosity, pressure, temperature specifications needs), configurations (e.g. pump size), and changing control needs (e.g. purging solutions of various viscosity used in making photographic products) require an open-loop control system that is not influenced by unreliable feedback measurements. Flow rates are predicted and the pump speeds are fixed using a simple, yet accurate, open-loop model for steady state control.

Closed-loop control using adaptive model parameters is used when the process is within the predetermined dead-band (e.g., +/−10% of set point) and the process conditions and configuration are assumed substantially fixed, i.e., linear and stationary (only small variations from aim), by the control system. The closed-loop control strategy (tuning or algorithm) is adjusted based on the conditions and configuration of the process (pressure, pump size, viscosity, temperature, etc.) to improve dynamic response, reduce variability and maintain low steady state error (accuracy) during unknown changes in the process.

The present invention improves flow capability by using open or closed-loop model-based control under specific (unknown or known) operating conditions. The system also improves the robustness of the process by incorporating known process conditions into the model-based control strategy and when unknown disturbances are expected, open-loop control is used to minimize unstable feedback control. This also improves reliability by preventing unstable control conditions from damaging process components.

### BRIEF DESCRIPTION OF THE DRAWINGS

FIG. 1 is a schematic of an exemplary process system in combination with a fluid transport or flow control system.

FIG. 2 is a block diagram of a model-based closed-loop flow control system in combination with the exemplary process system depicted in FIG. 1.

FIG. 3 is a block diagram of a model-based open-loop control system 50 in combination with the exemplary process system shown in FIG. 1.

FIG. 4 is a logic flow chart of the combined model-based open-loop and closed-loop control system of the present invention.

### DETAILED DESCRIPTION OF THE INVENTION

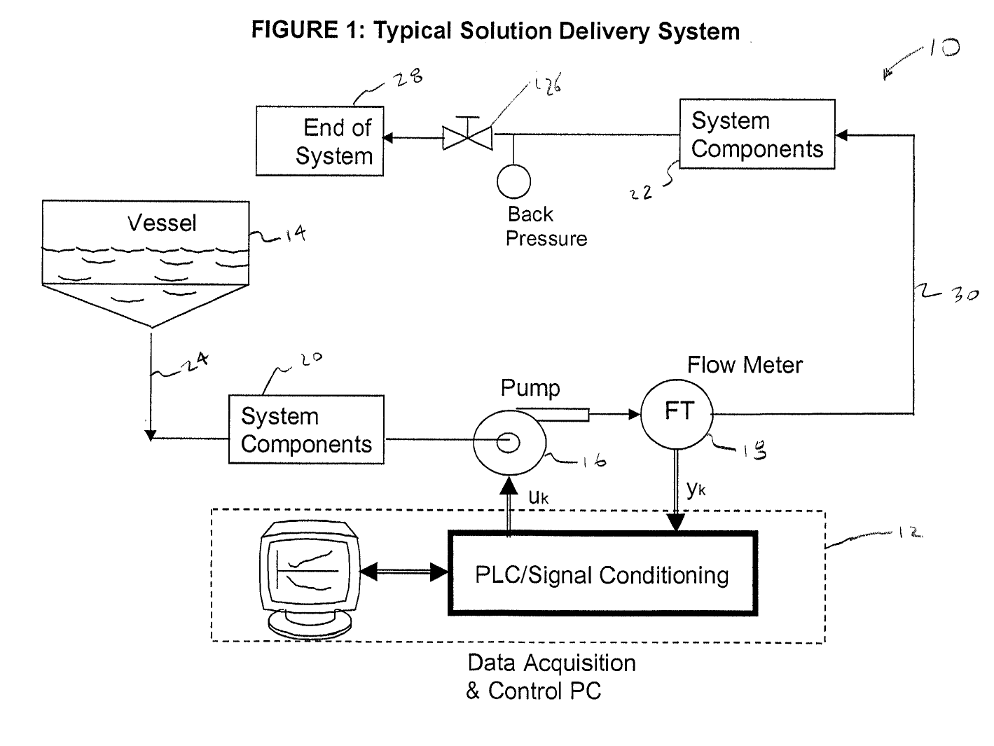

Turning first to FIG. 1 there is depicted a schematic of an exemplary process system 10 in combination with a fluid transport or flow control system 12 (such as a programmable logic controller [PLC]) for implementing the process control system of the present invention. The exemplary process system 10 includes a vessel 14, a pump 16, and a flow measurement device 18 such as a flow meter. The exemplary process system 10 may include other elements and system components 20, 22 such as, for example, additional vessels, pumps, flush valves, filters, sensors, bubble elimination equipment, mixers, etc. System components 20, 22 may be any additional components designed to perform additional functions inline with the fluid transport function and interact within the process system 10.

In the operation of the exemplary process system 10, liquid is supplied from vessel 14 via conduit 24 through system components 20 to pump 16. Pump 16 pumps liquid through flow meter 18, system components 22, back pressure controller 26 to the end of system 28 via conduit system 30.

The fluid transport or flow control system 12 needs to adapt to changes in the operating conditions caused by these various components as well as the changing requirements at the end-of-system 28. For example, back pressure control may be needed for a particular component to operate properly, thus requiring a back pressure controller 26. This will create the need to adapt to increases in back pressure on the flow control system 12. Other changes to the exemplary process system 10 may be made from time to time, such as, for example, pump sizes may be changed. A sensor or input to the controller 12 will compensate for this change to produce adequate flow control.

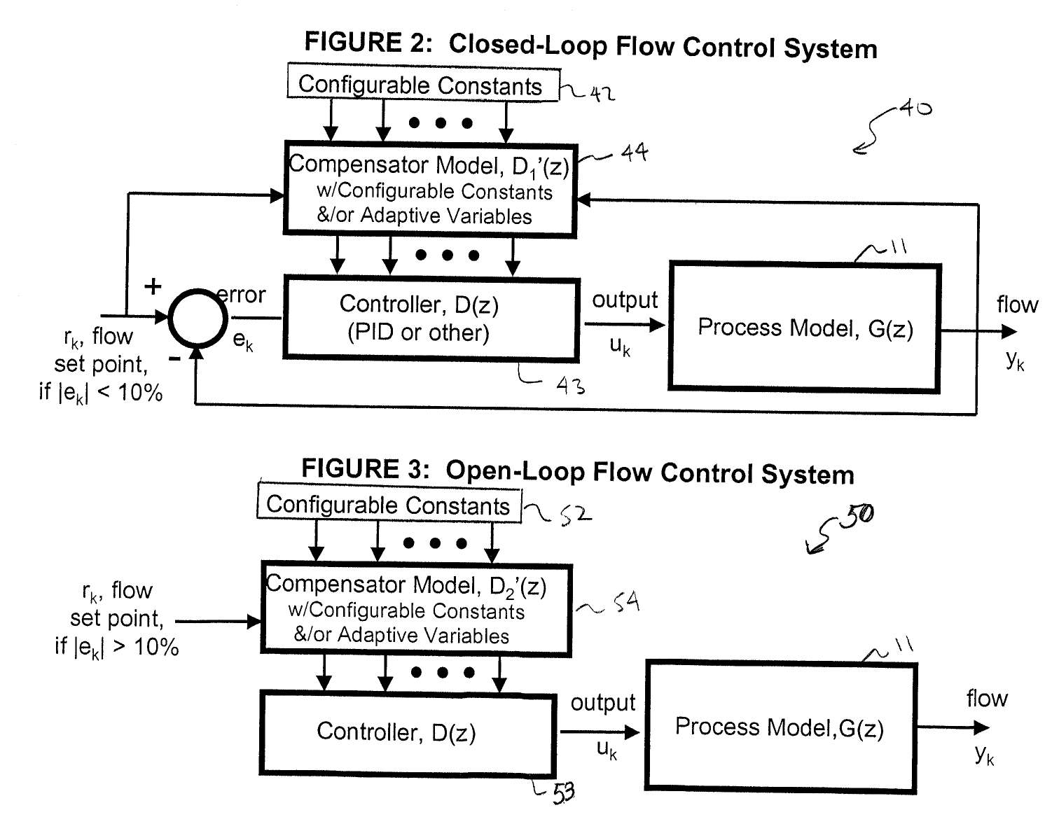

Looking next at FIG. 2 there is depicted a block diagram of a closed-loop flow control system 40 in combination with a process model 11 of the exemplary process system 10 shown in FIG. 1. Configurable constants 42 (physical characteristics of the process system being controlled) are employed that adapt the controller 43 (see Equation 6 below) to various conditions using compensator model 44 developed experimentally and/or theoretically.

FIG. 3 depicts a block diagram of an open-loop control system 50 in combination with the process model 11 of the exemplary process system 10 shown in FIG. 1. Configurable constants 52, which may be the same as or a subset of configurable constants 42, are employed that adapt the controller 53 to various conditions using compensator model 54 (see Equation 3 below).

An adequate process model 11 of a solution delivery system (that is, the exemplary process system 10) is needed to understand and simulate the system 10 under various conditions. FIGS. 2 and 3 depict control of the process model 11, G(z). However, in the practice of the control system of the present invention, operation of the actual process system 10 is controlled. The process model 11, however, may be needed as part of the compensator models 44, 54.

The process model 11 is of the following form:

Y(z)=G(z)U(z) Equation 1

Where, Y(z) is the output or flow rate, G(z) is the process model 11 transfer function, and U(z) is the system input or reference motor speed, all in the Z-transform domain. The process model 11, G(z), for the exemplary process is of the following explicit form:

$$G ( z ) = k \frac{( 1 + {ζ}_{0} {z}^{- 1} ) ( 1 + {ζ}_{1} {z}^{- 1} ) ( 1 + {ζ}_{2} {z}^{- 1} ) ( 1 + {ζ}_{3} {z}^{- 1} )}{( 1 + {ρ}_{0} {z}^{- 1} )} {z}^{- d } \qquad Equation 2$$

Where the model structure and parameters (system gain, k; poles, ρ; zeros, ζ; and delay, d) are based on the physical system (pipe size, pipe length, system geometry, pump, motor, etc.) and the solution properties (temperature, pressure, viscosity, density, etc.) in the Z-transform domain. The structure of the compensator model 54 and the dynamic parameters (poles and zeros) were found in this example to be fixed for a given operational range of the physical system 10. The system gain, k, is primarily effected by the pump size and solution properties. Therefore, the control gains would need to be corrected (adaptive gain control) based on these properties assuming the physical system 10 was fixed.

The block diagrams in FIGS. 2 and 3 illustrate the use of both open-loop and closed-loop (standard PID) control, respectively, with configurable constants 42, 52 that adapt the controllers 43, 53 to various conditions using compensator models 44, 54 developed experimentally and/or theoretically.

For this system, the control system 12 will choose between an open-loop (FIG. 3) and closed-loop (FIG. 2) control depending on the flow control error (actual-set point). Flow control will go to open-loop control if the flow control error is greater than a specific predetermined level (+/−X kg/min or % of aim). Also, it is possible to configure the control system compensator models 44, 54 to give adequate flow control capability, if the process system 10 is changing between states (process object may change, i.e., from cleaning to product flow).

In general, any decision logic could be used to go from open to closed-loop control. For example, operating conditions or parameters in system components 20, 22 as well as end-of-system 28 condition requirements may change with time (time-variant) throughout the operation of the process. These known operating conditions or parameters can be used to determine when the process 10 is switched between open-loop and closed-loop control and, include, process states or conditions such as, purging (water or product solutions with new product solutions), flushing, filling, cleaning, rinsing, hold flow, and product aim, or target flow.

If the conditions from above warrant open-loop control, then open-loop control is implemented using the model-based predictor or compensator 54 for an open-loop controller 53 depicted in FIG. 3 with configurable constants 52 that adapt the controller 53 to various conditions. Equation 3 is the compensator model 54 used to predict flow in this exemplary process in the discrete time domain.

$${r}_{k} = ρ \cdot C \cdot {u}_{k} [ {A}_{0} - {A}_{m} ( 1 - {e}^{j ( Δ P / η {u}_{k} )} ) ] \qquad Equation 3$$

Parameters include, but are not limited to the flow reference set point, rₖ; solution density, ρ; discrete time, k, pump size, C; solution viscosity, η; differential pressure, ΔP, across the pump; and proportionality constants Aₒ, Aₘ, and j. The parameters are used in the model to determine the control output, uₖ (pump speed in rpm). This controller output is fed to the actual process system 10, which is represented in Equation 1. The differential pressure, ΔP, across the pump 16 illustrated in FIG. 1 is directly effected by the back pressure controller 26, as well as the delivery system components (flow meter 18, system components 20, 22 and end of system 28), line sizes, and line length (i.e., flow vs pressure system curves), i.e., the configurable constants 52. The differential pressure, ΔP, can be calculated and used in the compensator model 54 knowing these parameters and the flow reference set point, rₖ, or measured experimentally.

If the operating conditions from above warrant closed-loop control, then closed-loop control is implemented using the model-based predictor or compensator 44 for closed-loop control logic (as depicted in FIG. 2) with configurable constants 42 that adapt the controller 43 to various conditions based on the process configuration 10. The relationship of the reference flow rate, R(z), and the output flow rate, Y(z), of the closed loop system is of the following form (see FIG. 2):

$$Y ( z ) = [ \frac{{D}^{′} ( z ) G ( z )}{1 + {D}^{′} ( z ) G ( z )} ] R ( z ) \qquad Equation 4$$

Where D′(z) is the control algorithm, G(z) is the process model, R(z) is the reference flow rate, and Y(z) is the actual flow rate all in the Z-transform domain.

For this example, D′(z) is an adaptive model-based controller, using a typical PID controller as a template (algorithm structure), but it could be any type of control algorithm.

A typical PID controller, D(z), (eg.—controller 43 in FIG. 2), is of the following form:

$$D ( z ) = \frac{U ( z )}{E ( z )} = [ {K}_{P} + \frac{{K}_{I} z}{( z - 1 )} + \frac{{K}_{D} ( z - 1 )}{z} ] + {K}_{F} \frac{R ( z )}{E ( Z )} \qquad Equation 5$$

Where, Kₚ=proportional gain, K_{I}=integral gain, K_{D}=derivative gain, and K_{F} is the feed-forward gain (E(z) is the flow error).

In general form, the adaptive controller (compensator model 44 in combination with controller 43 of FIG. 2) for the exemplary closed loop control system is of the following form:

$${D}^{′} ( z ) = [ {K}_{p} \{ C , Δ P , ρ , η \} + \frac{{K}_{I} \{ C , Δ P , ρ , η \} z}{( z - 1 )} + \frac{{K}_{D} \{ C , Δ P , ρ , η \} ( z - 1 )}{z} ] + {K}_{F} \{ C , Δ P , ρ , η \} \frac{R ( z )}{E ( z )} \qquad Equation 6$$

The PID gains (K_{P}, K_{I}, K_{D}, and K_{F}) in Equation 5 are determined from the gain transfer functions (K_{P}{C,ΔP,ρ,η}, K_{I}{C,ΔP,ρ,η}, K_{D}{C,ΔP,ρ,η}, and K_{F}{C,ΔP,ρ,η}) in compensator model 44 of FIG. 2 by entering the configurable constants 42. The gain transfer functions are determined from process model 11, G(z), in Equation 1, the steady state compensator model 44 in Equation 3, and a priori solution properties or process configuration information. For this example application, the proportional gain, K_{P}, and K_{D} can both be zero and the integral gain, K_{I}, a linear function of the pump size, C, i.e., K_{I}{C,ΔP,ρ,η}=K_{I}/C. Therefore the controller can simply be:

$${D}^{′} ( z ) = \frac{U ( z )}{E ( z )} = \frac{{K}_{I} z}{C ( z - 1 )} \qquad Equation 7$$

The configurable constants 42 are used in the compensator model 44 to determine the control variables. For a PID controller, these would include, but are not limited to, the proportional gain, K_{P}, integral gain, K_{I}, derivative gain, K_{D}, and/or a feed-forward gain, K_{F}. The controller will then determine the control output, uₖ (pump speed in rpm).

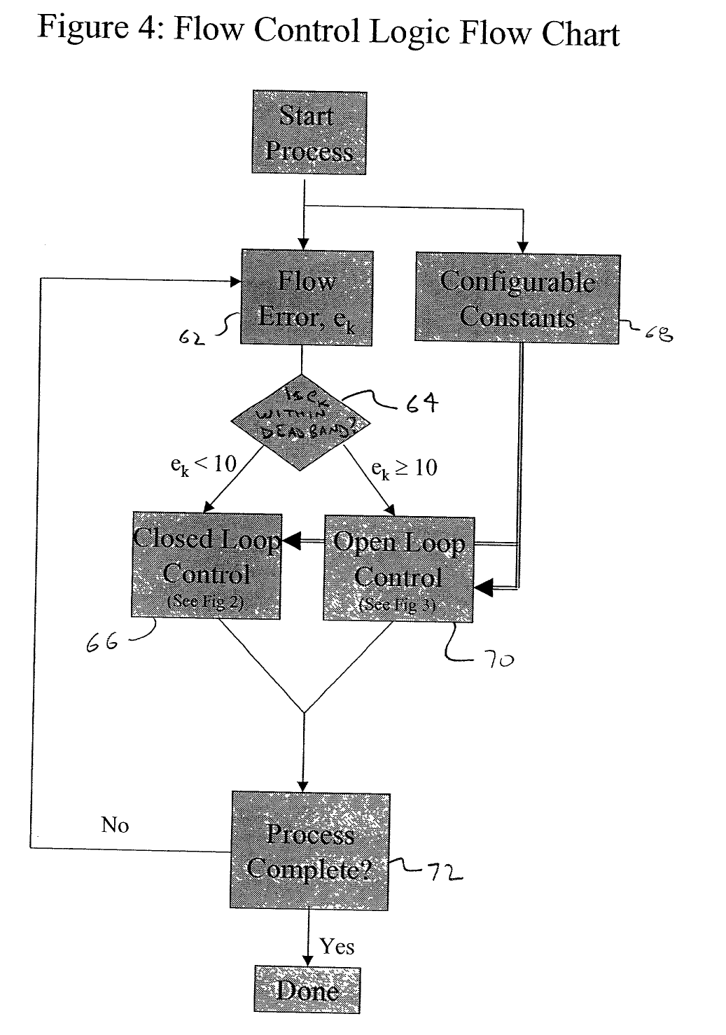

Looking next at FIG. 4 there is presented a logic flow chart of the combined open-loop and closed-loop control system of the present invention. FIG. 4 uses process flow rate as an exemplary operating process condition, which may be measured to decide when to use closed-loop control and when to use open-loop control. Per function box 60, the process is started. The flow rate, for example, of the process is measured and a flow rate error is determined per function box 62. A determination (per decision box 64) is then made as to whether the specific parameter measured (flow rate) is within a predetermined dead band (e.g.—the flow rate is within 10% of the model flow rate). If the answer is “yes”, then closed-loop controller is implemented per function box 66 using the configurable constants of the process being controlled (per function box 68) and the closed-loop compensator model. If the answer is “no”, then open-loop controller is implemented per function box 70 using the configurable constants of the process being controlled (per function box 68) and the open-loop compensator model. Per decision box 72, it is determined whether the process being controlled is completed. If the answer is “no”, then the parameter (in this example, the flow rate) is measured again per function box 62 and the steps of flow chart logic are repeated. The parameter being measured may be measured continuously or periodically.

From the foregoing, it will be seen that this invention is one well adapted to attain all of the ends and objects hereinabove set forth together with other advantages which are apparent and which are inherent to the process.

It will be understood that certain features and subcombinations are of utility and may be employed with reference to other features and subcombinations. This is contemplated by and is within the scope of the claims.

As many possible embodiments may be made of the invention without departing from the scope thereof, it is to be understood that all matter herein set forth and shown in the accompanying drawings is to be interpreted as illustrative and not in a limiting sense.

PARTS LIST:

10 Exemplary Process System
11 Process Model
12 Fluid Transport or Flow Control System
14 Vessel
16 Pump
18 Flow Measurement Device
20 System Components
22 System Components
24 Conduit
26 Back Pressure Controller
28 End of System
30 Conduit System
40 Closed-loop Flow Control System
42 Configurable Constants
43 Controller
44 Compensator Model
50 Open-loop Control System
52 Configurable Constants
53 Controller
54 Compensator Model
60 Function Box
62 Function Box
64 Decision Box
66 Function Box
68 Function Box
70 Function Box
72 Decision Box

What is claimed is:

1. A control system for controlling an operating process comprising:
(a) a controller;
(b) a first compensator model driving the controller to implement a closed-loop control system when at least one operating condition of the operating process is within a predetermined dead band; and
(c) a second compensator model determining an output for the controller to implement an open-loop control system when the at least one operating condition is outside the predetermined dead band.

2. A control system as recited in claim 1 wherein:
the first compensator model is employed in conjunction with a plurality of configurable constants that are associated with a plurality of physical parameters of the process being controlled.

3. A control system as recited in claim 1 wherein:
the second compensator model is employed in conjunction with a plurality of configurable constants that are associated with a plurality of physical parameters of the process being controlled.

4. A control system as recited in claim 2 wherein:
the second compensator model is employed in conjunction with a plurality of configurable constants that are associated with a plurality of physical parameters of the process being controlled.

5. A method for controlling an operating process comprising the steps of:
(a) measuring an operating process parameter;
(b) determining whether the operating process parameter is within a predetermined dead band;
(c) using closed loop control when the operating process parameter is within the predetermined dead band; and
(d) using open loop control when the operating process parameter is not within the predetermined dead band.

6. A method as recited in claim 5 further comprising the step of:
repeating steps (a) through (d) until process being controlled is completed.

7. A method as recited in claim 5 wherein:
closed loop control uses a first compensator model in conjunction with a plurality of configurable constants that are associated with a plurality of physical parameters of the process being controlled.

8. A method as recited in claim 6 wherein:
closed loop control uses a first compensator model in conjunction with a plurality of configurable constants that are associated with a plurality of physical parameters of the process being controlled.

9. A method as recited in claim 5 wherein:
open loop control uses a second compensator model in conjunction with a plurality of configurable constants that are associated with a plurality of physical parameters of the process being controlled.

10. A method as recited in claim 6 wherein:
open loop control uses a second compensator model in conjunction with a plurality of configurable constants that are associated with a plurality of physical parameters of the process being controlled.

11. A method as recited in claim 7 wherein:
open loop control uses a second compensator model in conjunction with a plurality of configurable constants that are associated with a plurality of physical parameters of the process being controlled.

12. A method as recited in claim 8 wherein:
open loop control uses a second compensator model in conjunction with a plurality of configurable constants that are associated with a plurality of physical parameters of the process being controlled.

13. A control system as recited in claim 1 wherein:
the first compensator model includes a model of the process being controlled.

14. A control system as recited in claim 1 wherein:
the second compensator model includes a model of the process being controlled.

15. A control system as recited in claim 14 wherein:
the second compensator model includes the model of the process being controlled.
